(19) United States
(12) Patent Application Publication
(10) Pub. No.: US 2009/0327979 A1
(43) Pub. Date: Dec. 31, 2009

(54) USER INTERFACE FOR A PERIPHERAL DEVICE

(75) Inventors: Ilkka Hemmo Haverinen, Tampere (FI); Mikko Antero Harju, Tampere (FI); Kimmo Matias Parssinen, Tampere (FI); Jani Kristian Nurminen, Lempaala (FI); Bogdan Florin Barliga, Tampere (FI); Marcel Cezar Vasilache, Tampere (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/164,832

(22) Filed: Jun. 30, 2008

(51) Int. Cl. G06F 3/14; G10L 11/00

(52) U.S. Cl. 715/864; 704/275; 704/E11.001

(57) ABSTRACT

A system and method that includes detecting an activation of an input application control key of a peripheral device, the peripheral device having a single application control input key, to open a initial application, the initial application becoming an active application, providing an identifier of the open application, and detecting a speech prompt to activate at least one function related to the active application.

### BACKGROUND

1. Field

The aspects of the disclosed embodiments generally relate to user interfaces and more particularly to a user interface for a peripheral device controlling applications of a device.

2. Brief Description of Related Developments

There are many applications that allow a user to provide voice commands to activate and control functions of the application. Headsets are one example of commonly used peripheral devices that allow for voice command applications. However, there can be many problems related to voice command applications when the user cannot see the display of the device. For example, the user may not necessarily know which application is currently active or open and therefore cannot provide the proper voice command instructions. Furthermore, if it is not possible to visualize the display, the user may not know which application is active or even which applications may be available to the user for selection and activation.

Some peripheral devices such as headset devices include input keys, such as buttons. However it may not always be clear what the function of the input key is in certain situations or applications. For example in some situations activating the input key could provide an “accept” function or a “cancel” function. Before making either choice, the user would need to be sure of the selection and may need a period of time in which to make such a determination. However that time cannot be too long, otherwise the system does not function efficiently.

In some situations the technical limitations of current speech recognition systems, and both accuracy and speed in portable devices, can provide a challenge for headset voice user interfaces. The speech recognition systems do make recognition errors. On the other hand, speed is an important value for recognition accuracy and can make a difference as to whether the user wants to use a system or not. Very long instructions or speech prompts are not necessarily an attractive option for such systems. Typically user interaction would preferably provide short prompts, such as text-to-speech (“TTS”) prompts, that allow ease-of-use with speed and efficiency.

### SUMMARY

The aspects of the disclosed embodiments are directed to at least a method, apparatus and computer program product. In one embodiment the method includes detecting an activation of an application control input key of a peripheral device to open an initial application. Once open, the initial application becomes an active application. An identifier of the open application is provided. A speech prompt to activate at least one function related to the active application can then be provided and the command can be executed by the active application upon detection of the input of the voice command, or a command to open a next application can be provided.

In one embodiment, after delivering the speech prompt to input a voice command to activate at least one function related to the active application, the application control input key can be used to open another or subsequent application, if a responsive voice command is not inputted. Once the subsequent application is opened, an identifier of the open subsequent application is provided and the subsequent application becomes the active application.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an example of a processes incorporating aspects of the disclosed embodiments;

FIGS. 3, 4 and 5 illustrates exemplary process flows incorporating aspects of the disclosed embodiments;

FIGS. 6A-6C are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(s)

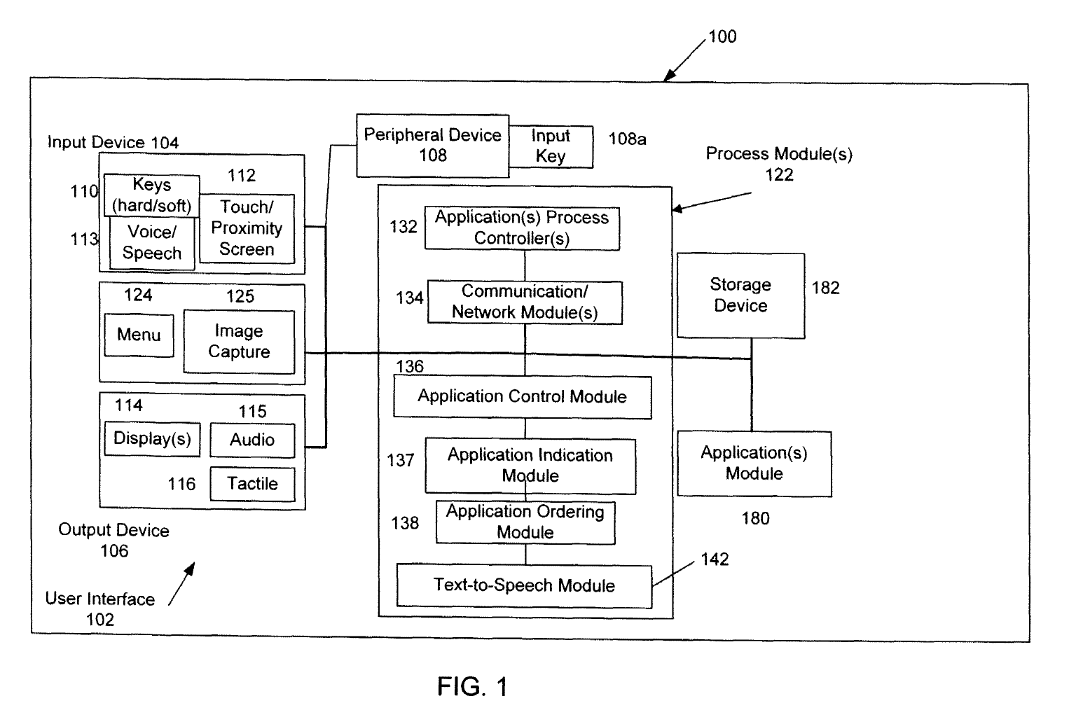

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide a user interface that takes into account many technical, practical and user friendly aspects related to speech recognition and text-to-speech conversion using a peripheral device 108, such as for example a headset device. A peripheral device, as that term is used herein, generally refers to any device capable of being coupled or attached to an electronic device, such as for example, computing devices, telecommunication devices or internet capable devices, that can be used to expand functionalities of the device, such as for example in the form of input and output devices. Although the aspects of the disclosed embodiments will generally be described with respect to a headset, it will be understood that the disclosed embodiments are not so limited. In alternate embodiments, any device that includes an application control input key, other than including a headset device can be encompassed by the disclosed embodiments. For example, the peripheral device 108 could include a remote control, camera, multimedia device, microphone, joystick, pointing device, trackball or keyboard for example. In a situation where the peripheral device 108 includes only a single application control input key and the system 100 does not include a display 114, or the user has limited access to a display 114, the aspects of the disclosed embodiments can provide, voice prompts, text-to-speech prompts, audible application opening indications and allow for pauses so that the user can access and switch between applications 180 of the system 100.

In one embodiment, the user opens an application by pressing the application control input key 108a associated with the headset 108. Although only a single key is shown in the drawings as being associated with the headset, it will be understood that the headset can include more than one input key for activating and controlling functions of the headset. An audible indication can be provided when the application opens. A prompt, such as for example a text-to-speech prompt, can be provided to prompt the input of a command or function of the application. In alternate embodiments, the prompt can comprise any suitable prompt including an audible or visual prompt, or a combination thereof. For example, if the system 100 includes lights or LEDS, the prompt could comprise illumination of one or more of the lights or LEDS, either alone or in combination with an audible prompt. Each application could be assigned a particular light or LED, or combination, which will allow each application to be uniquely identified by illumination of same. In one embodiment, each application could be assigned a number, and a representative number of lights could be illuminated, or a number displayed on a digital display or screen. In this way, the aspects of the disclosed embodiments are not limited to audio or speech applications, and can be applied where speech is not available or not desired.

If the user wishes to access or open a different application 180, a press of the application control input key 108a, before providing a voice command, can cause the next application to be opened or activated. In essence, the pressing of the application control input key 108a at certain times will scroll the user through the applications 180 of the device or system 100. A prompt, such as a speech prompt, will inform the user which application is open and allow the user to recognize the application and decide whether to exercise the application or search for a different application.

Referring to FIG. 1, the system 100 of the disclosed embodiments can generally include input device(s) 104, output device(s) 106, peripheral device 108 process module 122, applications module 180, and storage/memory device(s) 182. The peripheral device 108 can include an application control input key 108a. In an exemplary embodiment, the peripheral device 108 has a single application control input key that can be used to provide commands and instructions to the system 100 for controlling the applications 180 of the system 100. Although the peripheral device 108 can include more than one button or key as described above, only one input key 108a will be configured to control the status of the applications and system 100. The components described herein are merely exemplary and are not intended to encompass all components that can be included in the system 100. The system 100 can also include one or more processors or computer program products to execute the processes, methods, sequences, algorithms and instructions described herein.

The input device(s) 104 are generally configured to allow for the input of data, instructions and commands to the system 100. In one embodiment, the input device 104 can be configured to receive input commands remotely or from another device that is not local to the system 100. The input device 104 can include devices such as, for example, keys 110, voice/speech recognition system 113, touch screen 112, menu 124, a camera device 125 or such other image capturing system. In alternate embodiments the input device can comprise any suitable device(s) or means that allows or provides for the input and capture of data, information and/or instructions to a device, as described herein. The output device(s) 106 are configured to allow information and data to be presented via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 can be used to receive and display information pertaining to content, objects and targets, as will be described below. In one embodiment, the headset device 108 can be part of both the input and output devices 104, 106, as it can be used to input commands and instructions and receive data and information in the form of audible sounds, data and prompts. While certain devices are shown in FIG. 1, the scope of the disclosed embodiments is not limited by any one or more of these devices, and an exemplary embodiment can include, or exclude, one or more devices. For example, in one exemplary embodiment, the system 100 may not include a display or only provide a limited display, and the application control input devices, or application opening or activation function, may be limited to the key 108a of the peripheral device 108.

The process module 122 is generally configured to execute the processes and methods of the disclosed embodiments. The application process controller 132 can be configured to interface with the applications module 180, for example, and execute applications processes with respect to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

The process module 122 can also include an application control unit or module 136 that is configured to open and close applications based on respective inputs and commands received. In one embodiment, the application control unit 136 is configured to recognize an input received from the headset device application control or input key 108a and open the corresponding application.

The process module 122 can also include an application indication unit or module 137 that is configured to recognize an opening of an application and provide an indication, such as for example, an audible indication, to the user that a new application has opened. For example in one embodiment, when an application opens the user is provided with a tone or beep to indicate that a new application opens. In alternate embodiments, the indication can comprise any suitable indication that will inform a user that an application has opened.

In one embodiment, the process module 122 also includes application ordering system or module 138 that is configured to maintain a list of all applications 180 stored in, or available to the system 100. The list can be configured by the user or pre-set by the device and the list can comprise any suitable or desired ordering of applications. The application ordering module 138 can be configured to scroll through an application list as application opening commands are received by the application control module 136. When an application opening command is inputted and transmitted, the application ordering module 138 can determine which application 180 is next to be opened. This allows the user to, in essence, scroll through a list of applications using the application control input key 108a in accordance with the aspects of the disclosed embodiments, even though the user may not necessarily be able to visualize the application list, the application or the next application. The set of applications 180 that are selected to be active in this voice-enabled user interface can be a preset default set of applications. In one embodiment the set of applications 180 can be configurable by the user. In an exemplary embodiment, the user can remove unwanted applications from the list of active applications. In one embodiment, the application ordering module 138 can be configured to assign each application a unique identifier, such as for example, an audible or visual identifier or indicator. For example, the indicator can be an audible indicator, such as a beep, tone or other unique sound. In one embodiment, the indicator is a text-to-speech prompt, such as the application name. In another embodiment, the indicator is a visual indicator, such as the illumination of one or more LEDs, or an image on a display. Alternatively, the indicator is tactile, such as for example, a vibration or pulsing action.

In one embodiment, the system 100 can also include a text-to-speech module and voice recognition system 142 that provides and receives voice commands, prompts and instructions. In the exemplary embodiment, these commands prompt and instructions are received and delivered through the peripheral device 108. The text-to-speech module 142 can interpret an application state and provide a voice prompt based on the application state that prompts for a command or input to take the application to the next state. The aspects of the disclosed embodiments allow a device to change application states or to move from one application to another when the application control input key 108a of the peripheral device 108 is activated. When an application is activated or opened, the text-to-speech module 142 can provide a prompt that indicates the application name of the open application. Activation of the application control input key 108a can cause a next application to be opened. When the desired application is reached, a voice command to activate a function of the application can be provided, if the user is familiar with the voice commands of the application, or the user can wait for an appropriate speech prompt that asks for a command input. After recognition of the opened application, the peripheral device application control input key 108a can be used to cancel the operation. This allows the user to quickly browse an application list. Different audio indications or sounds can be used during each process of the interaction with the headset user interface system. Using different sounds can allow the user to identify the particular state of the user interface, application and process. For example, the application opening indication can be one type of audio, while the execution of one or more application commands and functions can have a different sound or audio file associated therewith. Closing an application can be associated with a different sound or audio file. In alternate embodiments, any suitable audio indications and/or sounds can be used in the different stages of the process and processes described herein.

The user interface system of the disclosed embodiments takes advantage of a situation in which the peripheral device 108 includes only a single application control input key 108a, and a limited or no display. Audio sounds, such as beeps can inform a user that a new application is opening and speech prompts provide the user with enough information to identify the open application. In one embodiment, this can include the name of the application. By opening the applications separately, the size of the vocabulary can be limited for voice recognition purposes. Since a speech or voice prompt can be provided each time an application is opened, the correct application can easily and quickly be found. Experienced users can immediately access the functions of an application by inputting an appropriate command immediately after hearing the application name. However in one embodiment, short explanatory speech prompts can be provided for non-experienced users to provide guidance as to the instructions or prompts that are required to access the application functions. The aspects of the disclosed embodiments do not require that the user remembers any phrases or commands that the speech or voice recognition system is trained to recognize with respect to the applications and their names. If the user has accessed the wrong application or receives the wrong recognition result, the peripheral device application control input key 108a can be used to cancel or exit the application. Similar logic and patterns are used throughout all of the applications. The user can also pre-sort through different applications so that the order of the applications is logical or optimal for the best use or user experience.

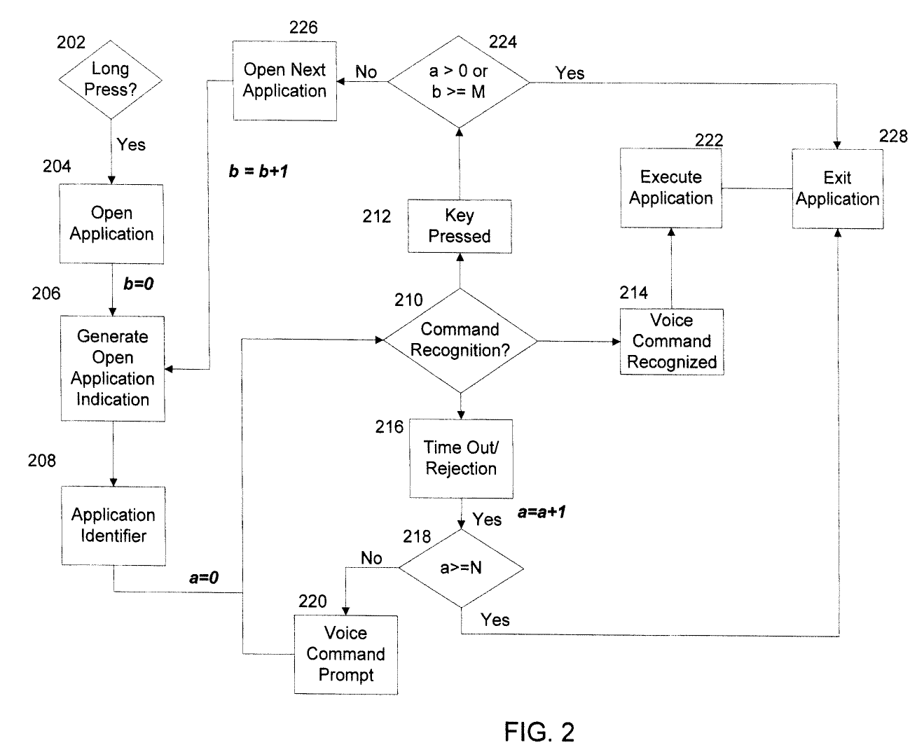

Referring to FIG. 2, one example of an exemplary process incorporating aspects of the disclosed embodiments is illustrated. In this example, the peripheral device 108 includes a single application control input key 108a. The user is able to input commands and instructions to the system by pressing the application control input key 108a or providing voice commands to the voice recognition system 142. Outputs from the system are delivered or outputted by an audio output unit of the peripheral device 108. Communication begins with detection of an activation of the input key 108a. When a long press of the application control input key 108a is detected 202, an initial application is opened 204. In one embodiment the initial application comprises the first application in a list maintained by the application ordering system 138. The initial application can be predetermined by the user or a default application set by the system. In alternate embodiments any suitable criteria can be used to determine the initial or default application.

When the initial application opens, in one embodiment, an open application tone is generated 206. In one embodiment the open application tone comprises a short beep or other similar sound. In alternate embodiments, any suitable audible indication or tone can be used to indicate to the user that an application has opened.

After the open application tone, an application identifier or similar prompt can be provided 208. In one embodiment, the text-to-speech module 142 of FIG. 1 provides a speech prompt indicating the name or other identifier of the application. In alternate embodiments the application indication prompt can be any suitable prompt or indication that identifies the open application.

In one embodiment, generation of the open application indication 206 and application identifier 208 can be combined into a single function. For example, in a voice dialing application, both the open application indication and the application identifier can be identified by the same tone, such as a short sound resembling a dial tone. When the application is a music search, both the open application and application identifier can be identified by a short segment of music. The foregoing examples generally require that the user be familiar with the application identifier for each application. In an embodiment where the user is not familiar with the application identifier, the user can rely on voice commands and prompts, such as the voice command prompt 220. In a dialing application, the prompt can be “To dial a contact, say a contact name.” This prompt can be the application identifier in this type of situation.

In one embodiment, the application identifier prompt 208 will also include a prompt or request for the user to provide a voice command to activate at least one function of the open application.

After the application identifier prompt 208 is generated, in one embodiment it is determined 210 whether a responsive command is detected. In one embodiment, three different actions can be detected and/or recognized in this state, which can be referred to as a speech recognition, or user interface engine state. These actions can include a key press 212, a voice command 214 or a time out or rejection 216.

If a key press 212 is detected, in one embodiment, it is determined 224 if the number of attempts “a” to open an application or detect an input command exceeds a pre-determined number, or whether there are any more applications for the user to browse. In this determination, the variable “a” is the number of retries and N is the number of allowed retries. To determine whether there are any more available applications, “b”, the number of applications checked by the user, is compared to “M”, the total number of applications available. In one embodiment, the number of permitted retries “N” will be 0 or 1. Thus, in step 224, it is determined whether the user is in the voice command prompt state, where a>0, or if the user has browsed all of the applications, where b>=M. If the answer is no, the next application can be opened 226. When the next application opens, the value of variable “b” is incremented by 1. (b=b+1). If the answer to state 224 is yes, the application is closed or exits 228.

If, after the application identifier prompt 208, a voice command 214 is detected or recognized the application or function corresponding to the detected command can be executed 222.

In one embodiment, if, after the application identifier prompt 208, it is determined that a voice command input 214 is not detected or recognized and a input key 108a has not been activated 212, it is determined 216 whether a time-out is detected or a rejection is activated. A time-out can comprise a predetermined time period that has elapsed since the application identifier prompt 208. If a time-out or rejection 216 is detected, the variable “a”, the number if retries, is incremented by one. A determination 218 is made as to whether the number of retries “a” exceeds or is equal to the number of allowed retries “N”. If no, the system 100 can provide a prompt 220, such as a voice command prompt to advise the user that the system 100 is still waiting for an appropriate input command, such as a key press 212 or voice command 214. The system 100 can remain in this speech recognition/UI state while waiting for a command input 210. If number of retries “a” is greater than or equal to the number “N” of retries allowed, or permitted retries, the application exits.

When the number of retries “a” is not greater than or equal to “N” a voice command or other suitable prompt 220 can be generated that represents a request for an input of a command with respect to the open application. Thus, in a situation where the user is unfamiliar with or unsure of the voice command input to provide that corresponds to a function of the open application, by waiting, the application can provide appropriate guidance and instruction to the user. For example, in a dialing application, the prompt can be a voice prompt such as “please say number.” In alternate embodiment where the prompt is a visual cue, an indicator on the device may be highlighted that corresponds to an input key for the desired function. For example, in a phone or dialing application, the address book function key (hard or soft key) can be highlighted, prompting the user to select a contact from the address book, or a list of contacts might be displayed with a prompt to the user to select one of the contacts or input a dialing number. With respect to the example above, if the device includes a display, the text “please input number” might be displayed. Thus, although the exemplary embodiments are described with respect to voice command prompts and inputs, in alternate embodiments other audio and visual prompts and commands can be utilized. If a command 214 is detected, the appropriate function of the application will be executed 222, including exiting 228 the application, for example.

In one embodiment, detection of the activation of the application control input key 108a prior to a voice command input 214 will cause the next application, as determined by the application ordering system 138, to open 226. In this way, the user can essentially “scroll” through a list of applications even though the user might not be able to visualize the application list.

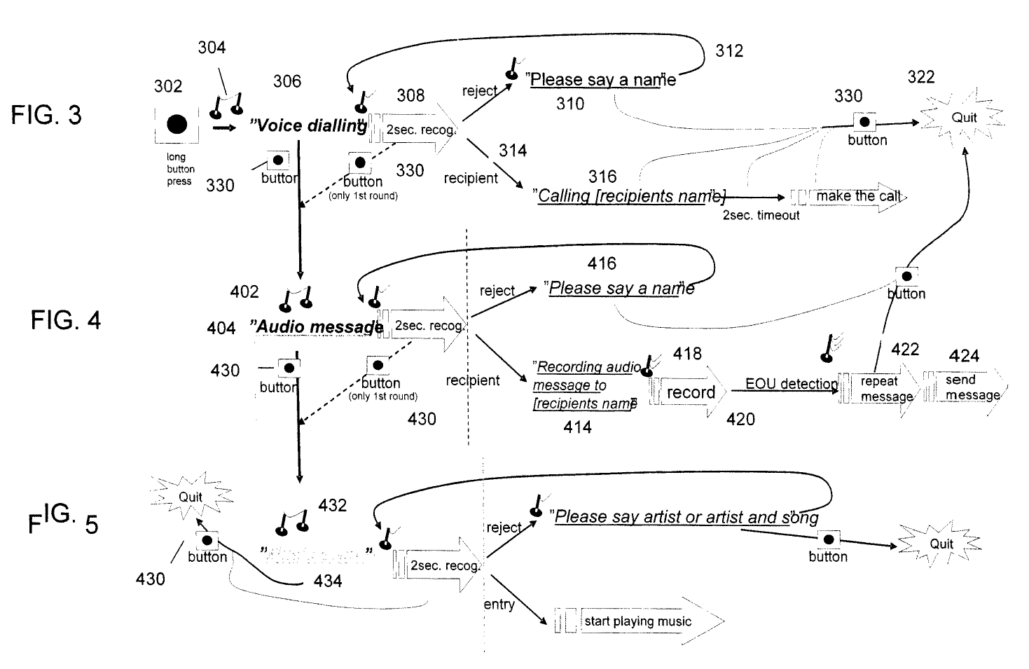

FIGS. 3, 4 and 5 illustrate an exemplary implementations or process flows of the disclosed embodiments. In this example, there are three applications stored or accessible to the applications module 180 of FIG. 1. The three applications of this example are Voice Dialing, Audio Messaging and Music Search. In alternate embodiments any suitable number and types of applications can be used. The scope of the disclosed embodiments is not limited by the number or types of applications that may be available.

As shown in FIG. 3, a long input key press 302, to initiate communication with the user interface, generates a special beep sound 304 that indicates a new application is activated or open. In this example the initial application is the “voice dialing” application. The prompt in this example is a speech prompt that states the name 306 of the application that is opened, which in this case is “voice dialing”. Thus, the user is informed as to the identity of the open application.

After hearing the speech prompt “voice dialing” 306, the user can provide a responsive or command instruction, wait for another speech prompt to input a command, or press the application control input key 330 if the voice dialing application is not the desired application. For example, if the user does not provide a voice command and does not press the application control input key 330, the system goes into a voice dialing mode or function and a speech prompt, such as “Please say a name” is provided 310. The speech prompt 310 can be automatically provided after a predetermined time period 308 has elapsed. The time period 308 should be sufficient to allow the user to either provide a voice command or press the application control input key 330. In this example, the predetermined time period 308 is approximately two seconds. However in alternate embodiments, any suitable time period can be used that provides the user with sufficient time to provide an appropriate input to the system 100.

After the voice prompt 310, the user will have a sufficient period within which to provide a response command 312, which in this case is to say the recipient's name. After the recipient's name is recognized 314, the call can be made. The speech prompt 316 can be provided to inform the user that the call is in process. In one embodiment, during the speech prompt time and for a predetermined period of time thereafter, the application control input key 330 can be enabled so that pressing the input key 330 will cancel 322 the call. In one embodiment, the function of the application control key button 108a can vary depending on the particular application in the task or function being executed. If the call is not canceled, the application will make the call 320 in a suitable fashion.

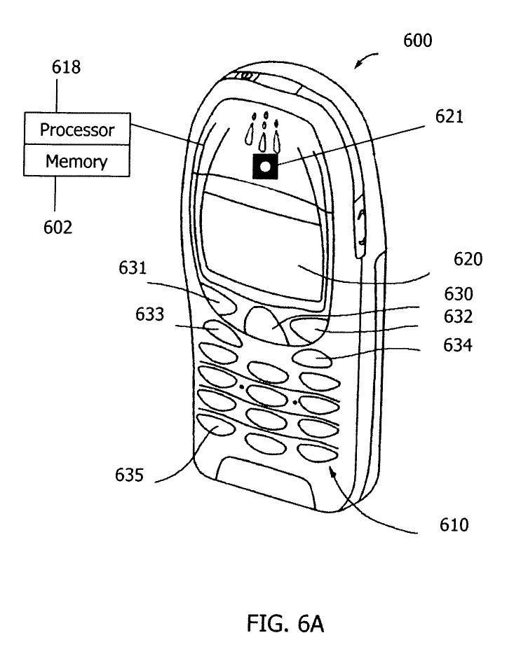

In one embodiment, referring to FIG. 4, if after hearing the speech prompt “voice dialing”, the user does not want to engage in this application, the user can press 330 the application control input key 430 to open the next application of the system as determined, for example, by the application ordering system 138. In this example, the next application to be opened is the “audio message” application. As shown in FIG. 4, when the audio message application opens, a beep or similar audible tone 402 is provided to inform the user that a new application has opened. A speech prompt 404 informing the user of the application name “audio message” is provided. The process then proceeds in a manner similar to that shown with respect to FIG. 3, where the user can provide a voice prompt 414, wait for a command 416 or press the application control input key 430 to go to a next application. In this example if the user does not provide an input, the voice prompt “please say a name” 416 is provided. Once the user provides the name 414, a beep or other suitable indication indicates that the recording has started. During the recording process 420, other sound or indications can be provided that the recording is ongoing. After the recording is complete, the message can be played back 422. The user can then send 424 the message or cancel the message using the application control input key 430 as indicated by the system. In these examples, the recipient's name is entered first because recognition errors that happen in the recipient's name should be correctly recognized prior to starting any recording. It is desirable to avoid manual browsing of the phonebook.

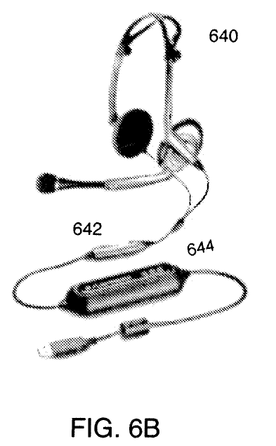

Referring to FIG. 5, if the user does not want the audio message application of FIG. 4, the press of the application control input key 430 will activate the next application. In one embodiment, the press of the application control input key 430 to activate a next application will automatically cancel or close the prior application. In another embodiment, the user can press the input key in a repetitive fashion a number of times that corresponds to the number of applications previously opened. Thus, in the example of FIG. 5, pressing the application control input key twice will cancel the prior two applications and open the next application, which in this case is “music search”. Here again, after the press of the application control input key 430 the music search application is opened and an opening indication 432 is provided. A speech prompt 434 indicating the application name “music search” is provided. The process relating to the application and further commands proceeds in a manner similar to that described above.

Referring to FIG. 1, in one embodiment, the user interface of the disclosed embodiments can be implemented on or in a device that includes a touch screen display, proximity screen device or other graphical user interface. Although a display associated with the system 100, it will be understood that a display is not essential to the user interface of the disclosed embodiments. In an exemplary embodiment, the display is limited or not available. In alternate embodiments, the aspects of the user interface disclosed herein could be embodied on any suitable device that will allow the selection and activation of applications or system content when a display is not present.

In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch-screen display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

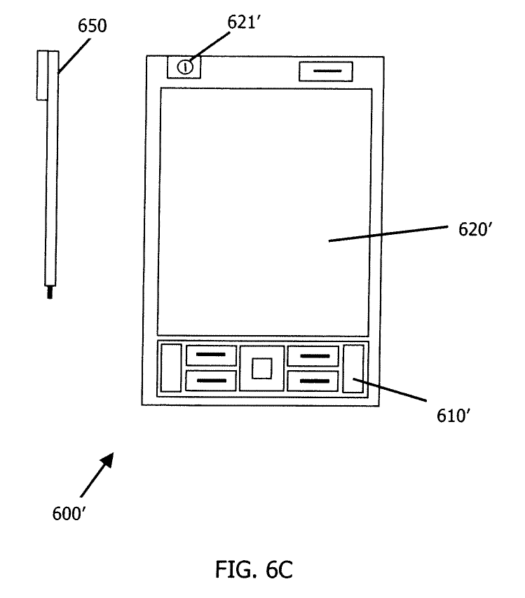

Some examples of devices on which aspects of the disclosed embodiments can be practiced are illustrated with respect to FIGS. 6A-6C. The devices are merely exemplary and are not intended to encompass all possible devices or all aspects of devices on which the disclosed embodiments can be practiced. The aspects of the disclosed embodiments can rely on very basic capabilities of devices and their user interface. Input keys can be used for selecting the various selection criteria and links, and a scroll function can be used to move to and select item(s).

As shown in FIG. 6A, in one embodiment, the terminal or mobile communications device 600 may have a keypad 610 as an input device and a display 620 for an output device. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621, as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection and other input and commands. In alternate embodiments, any suitable pointing or touch device may be used. In other alternate embodiments, the display may be a conventional display. The device 600 may also include other suitable features such as, for example a loud speaker, tactile feedback devices or connectivity port. The mobile communications device may have a processor 618 connected to the display for processing user inputs and displaying information and links on the display 620, as well as carrying out the method steps described herein. A memory 602 may be connected to the processor 618 for storing any suitable information, data, settings and/or applications associated with the mobile communications device 600.

FIG. 6B illustrates an exemplary headset device 640. As shown in FIG. 6B, the headset device includes a single application control input key or button 642. Other keys or buttons 644 can also be included with the headset device for controlling other aspects of the headset, such as for example, a power-on button, mute or push-to-talk button.

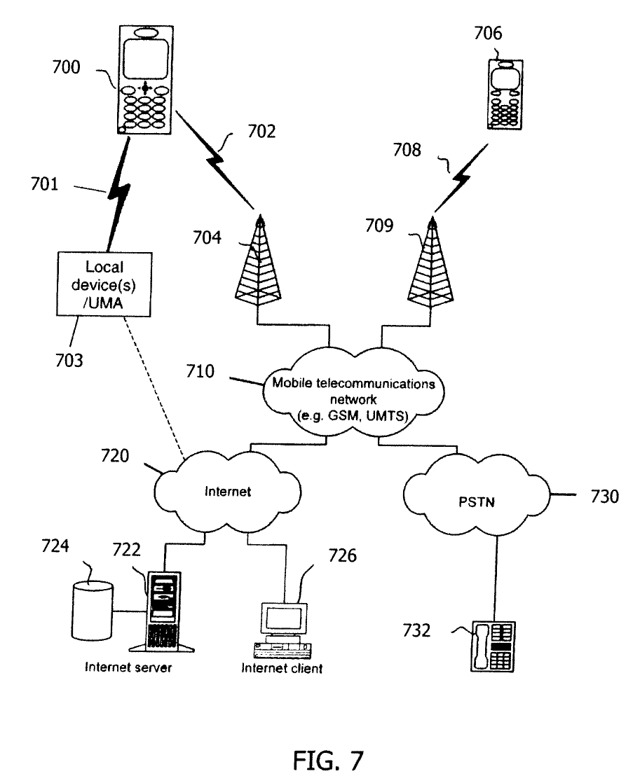

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a personal computer 751 and/or an internet server 722.

In one embodiment the system is configured to enable any one or combination of chat messaging, instant messaging, text messaging and/or electronic mail. It is to be noted that for different embodiments of the mobile terminal 700 and in different situations, some of the telecommunications services indicated above may or may not be available. The aspects of the disclosed embodiments are not limited to any particular set of services or communication system or protocol in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communications module 134 that is configured to interact with, and communicate to/from, the system described with respect to FIG. 7.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be, for example, a personal digital assistant (PDA) style device 600′ illustrated in FIG. 6C. The personal digital assistant 600′ may have a keypad 610′, a touch screen display 620′, camera 621′ and a pointing device 650 for use on the touch screen display 620′. In still other alternate embodiments, the device may be a personal computer, tablet computer, touch pad device, Internet tablet, laptop or desktop computer, mobile terminal, cellular/mobile phone, multimedia device, personal communicator, television or television set top box, digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and GPS capability.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, establishing and selecting search and relationship criteria and navigating among the search results. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications and state change requests. Depending on the inputs, the process module 122 interprets the commands and directs the process control 132 to execute the commands accordingly in conjunction with the other modules, such as application control module 136, application indication module 137, application ordering module 138 and text-to-speech module 142.

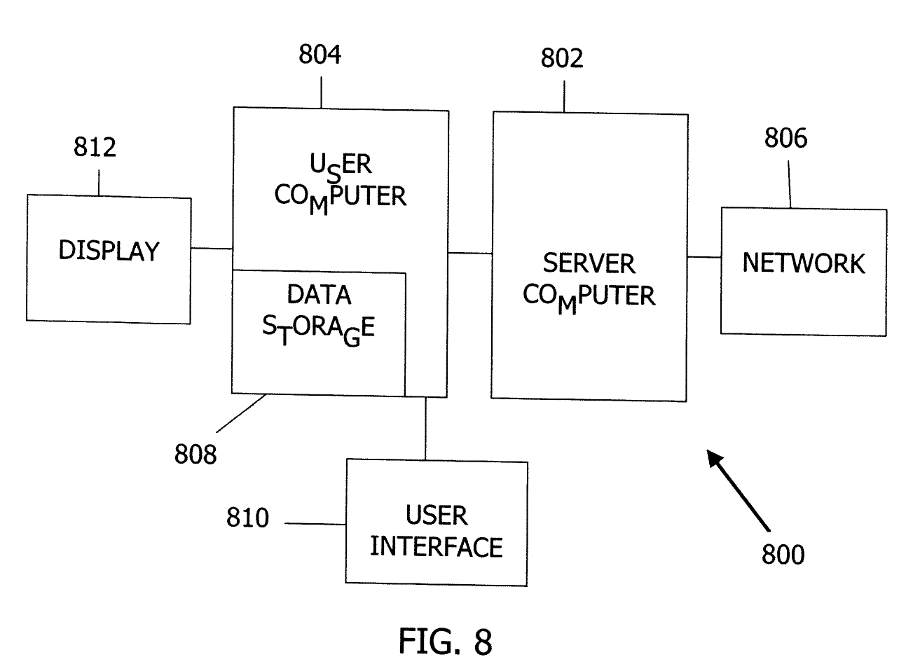

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in a memory or memory medium that is external to, or remote from, the apparatus 800. The memory can be direct coupled or wirelessly coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection or line, communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include one or more processors for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

The aspects of the disclosed embodiments are suitable for all applications that require the recognition of a command or selection from a list of items or search from this vocabulary. The user can press the application control input key 108a to open a new application, and a prompt can be provided to inform the user that the application has been opened as well as identify the application to the user. The user can either provide a voice command to the application or press the application control input key again to open another application. After recognition of the voice command based on the recognition results, the wanted action can be executed.

The user interface of the disclosed embodiments is intuitive for the first time user since the same pattern repeats for each process. First, the user selects the application by activating the application control input key, the recipient or command is recognized, and the wanted action takes place. If a recognition error occurs the action can be canceled by pressing the application control input key 108a. Applications can be pre-sorted to a desired order and unused or unwanted application can be removed from the active voice user input device application list. Recognition errors are minimized compared to “free” recognition, since only the vocabulary of the open application is active.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting an activation of an application control input key of a peripheral device to open an initial application, the peripheral device having a single application control input key, the initial application becoming an active application;
providing an application identification signal; and
detecting a command to execute at least one function related to the active application or a command to open a next application.

2. The method of claim 1 further comprising executing the at least one function of the active application upon detection of the command.

3. The method of claim 1 further comprising providing an audible acknowledgement of the opening of the active application.

4. The method of claim 1 further comprising providing a speech prompt to input a voice command to activate at least one function related to the active application.

5. The method of claim 1 further comprising:
detecting a subsequent activation of the application control input key; and
opening the next application in response to detecting the subsequent activation, the next application becoming the active application.

6. The method of claim 5 wherein detecting a subsequent activation of the application control input key to open the next application comprises detecting a short press of the input key.

7. The method of claim 6 wherein detecting multiple, sequential short presses of the application control input key advances an application selection device to a next application in an application list corresponding to a number of detected key inputs following the initial application.

8. The method of claim 1 further comprising:
providing a prompt to input a command to activate at least one function related to the active application; and
detecting an activation of the application control input key to open the next application.

9. The method of claim 1 wherein detecting an activation of the application control input key to activate the initial application comprises detecting a long press of the input key.

10. The method of claim 1 wherein the application identification signal is an audible tone generated or a speech generation of a name of the active application when an application opens.

11. The method of claim 1 wherein detecting the command to execute the at least one function related to the active application comprises detecting a voice prompt corresponding to an application function.

12. The method of claim 1 wherein the peripheral device comprises a headset device.

13. An apparatus comprising:
an application control module or unit configured to open an application upon detection of a command from an application control input key of a peripheral device coupled to the application control unit;
an application indication module configured to provide an identifier of the open application for identifying the open application; and
wherein the application control module is further configured to detect a further command to execute a function related to the open application or to open a next application.

14. The apparatus of claim 13 further comprising an application indication unit that is configured to provide at least one audible indication of an opening of an application.

15. The apparatus of claim 13 further comprising that the application control unit is configured to open a default, initial application upon detection of a long press command from the application control input key, and open a subsequent application upon detection of a subsequent short press of the application control input key, prior to the open application detecting a command to initiate a function related to the open application.

16. The apparatus of claim 15 further comprising an application ordering module that is configured to detect sequential subsequent short presses of the application control input key, identify an application from an application list that corresponds to a number of sequential subsequent short presses detected, wherein the application control unit is configured to open the identified application.

17. The apparatus of claim 13 further comprising that the application control unit is configured to:
detect an application opening request by activation of the application control input key;
determine if the application control input key activation is a request to open an initial application or a subsequent application;
open the initial application or the subsequent application depending on the request.

18. The apparatus of claim 17 further comprising that the application indication unit is further configured to detect the opening of the initial application or subsequent application and generate an audible tone in the peripheral device as an indication of the opening of the initial or subsequent application.

19. The apparatus of claim 13 further comprising that the application control unit is configured to generate a speech prompt corresponding to at least one function of the open application if a request to open another application is not detected within a pre-determined time period after the application is opened.

20. The apparatus of claim 13 further comprising a speech recognition module configured to detect a voice command to execute a function related to the open application and provide speech prompts related to functions of the open application and identification of the application.

21. The apparatus of claim 13 wherein the peripheral device is a headset.

22. A system comprising:
a device including at least one processor configured to store and execute at least one application;
a peripheral unit configured to be coupled to the device to provide and receive command prompts and communications, the peripheral unit having a single application control input key;
an application control unit configured to open an application upon detection of a command from the application control input key;
an application indication module configured to provide an identifier of the open application; and
wherein the application control unit is further configured to detect a command to execute a function related to the open application or open a next application.

23. The system of claim 22 wherein the application indication module is further configured to provide an acknowledgement that the application is opened.

24. The system of claim 22 further comprising a voice recognition unit configured to provide a prompt for a voice command related to at least one function of the open application.

25. The system of claim 22 wherein the application control unit is further configured to detect a sequential series of input commands from the application control input key, advance an application selection control to an application in a list of applications that corresponds to a number of input commands detected, and open the corresponding application.

26. The system of claim 22 wherein the peripheral device is a headset device.

27. The system of claim 22 wherein the device is a mobile telecommunications device.

28. A computer program product comprising:
a computer useable medium stored in a memory having computer readable program code means embodied therein, the computer readable program code means in the computer program product comprising:
computer readable program code means for causing a processing device to detect an activation of an application control input key of a peripheral device, the peripheral device having a single application control input key;
computer readable program code means for causing a processing device to open an initial application, the initial application becoming an active application;
computer readable program code means for causing a processing device to provide an application identification signal; and
computer readable program code means for causing a processing device to detect a voice command to activate at least one function related to the active application or a command to open a next application.

29. The computer program product of claim 28 wherein the computer readable program code means is stored in a memory of a mobile communications device.
